(19) United States
(12) Patent Application Publication
(10) Pub. No.: US 2005/0180393 A1
(43) Pub. Date: Aug. 18, 2005

(54) Providing advanced call features to an analog telephone using a media gateway

(76) Inventor: Michael A. Skubisz, Durham, NH (US)

Correspondence Address: DEVINE, MILLIMET & BRANCH, P.A., 111 AMHERST STREET, BOX 719, MANCHESTER, NH, 03105, US

(21) Appl. No.: 10/780,035

(22) Filed: Feb. 17, 2004

(51) Int. Cl. H04L 12/66

(52) U.S. Cl. 370/352

(57) ABSTRACT

An intelligent media gateway provides packet-switched telephony and advanced telephone call features to an analog telephone handset. The intelligent media gateway is connected between the analog telephone handset and a network, such as the Internet or other type of IP network. Telephone calls are transmitted and received by the intelligent media gateway using a packet-switched telephony protocol, such as VoIP. The advanced telephone call features are handled by an intelligent call agent located on the media gateway, which can be configured by the user.

### TECHNICAL FIELD

The present invention relates to packet-switched telephony and more particularly, to a method and apparatus for providing advanced call features to an analog telephone using IP telephony.

### BACKGROUND INFORMATION

Telephony is the technology associated with the electronic transmission of voice, fax or other information between distant parties using a telephone. The development of telephony technology has resulted in advanced telephony services or features, such as call waiting, call transferring, call forwarding and call blocking. These advanced telephony services or features are often handled by the telephone company, particularly for residential telephone services. When these features are handled by the telephone company, however, the residential user has less control over the activation and configuration of these features. Sophisticated telephones incorporating advanced telephony features are available but are expensive and are more commonly used by businesses.

Telephony services can now be provided by using packet-switched connections to exchange voice, fax and other forms of information that have traditionally been carried over the dedicated circuit-switched connections of the public switched telephone network (PSTN). In particular, the internet protocol (IP) can be used to provide telephony services over the Internet or other type of IP network. Using IP telephony, telephone calls travel as packets of data. One type of IP telephony service is implemented using voice over IP (VoIP) standards to manage the delivery of voice information. Media gateways are used to convert between the digital voice data and the analog voice signals. However, the residential user's ability to control and configure a media gateway has been limited.

Accordingly, there is a need for an apparatus that provides advanced telephony features to a conventional analog telephone using packet-switched telephony and that allows a customer (e.g., a residential user) to activate and configure the advanced telephony features locally.

### SUMMARY

In accordance with one aspect of the present invention, an intelligent media gateway provides telephone call features to an analog telephone using packet-switched telephony. The intelligent media gateway comprises at least one broadband connection for receiving and transmitting digital data corresponding to inbound and outbound telephone calls, respectively. The digital data includes telephone call data and voice data. At least one telephone interface receives and transmits analog voice signals corresponding to the inbound and the outbound telephone calls. A call processing system processes the inbound and outbound telephone calls and converts between the voice data and the analog voice signals. The call processing system includes an intelligent call agent for managing the telephone calls according to the telephone call data and user defined rules. A user interface system provides a user interface for configuring the intelligent call agent and for creating the user define rules.

In accordance with another aspect of the present invention, a method is provided for managing packet-switched telephone calls. According to the method, call handling rules are provided on a media gateway for handling inbound and/or outbound telephone calls and a user interface is provided to the media gateway for configuring the call handling rules. When an invitation to accept an inbound telephone call using packet-switched telephony is received, call handling rules on the media gateway are consulted to determine how the inbound telephone call is handled. The inbound telephone call is then processed based on the call handling rules.

### BRIEF DESCRIPTION OF THE DRAWINGS

These and other features and advantages of the present invention will be better understood by reading the following detailed description, taken together with the drawings wherein:

FIG. 1 is a schematic diagram of an internet telephony system, according to one embodiment of the present invention.

FIG. 2 is a functional block diagram of an intelligent internet telephony apparatus, according to one embodiment of the present invention.

FIG. 3 is a flow chart illustrating outbound call processing, according to one embodiment of the present invention.

FIG. 4 is a flow chart illustrating outbound call processing, according to one embodiment of the present invention.

FIGS. 5-9 are screen shots of the user interface for the intelligent call agent, according to one embodiment of the invention.

### DETAILED DESCRIPTION OF THE PREFERRED EMBODIMENTS

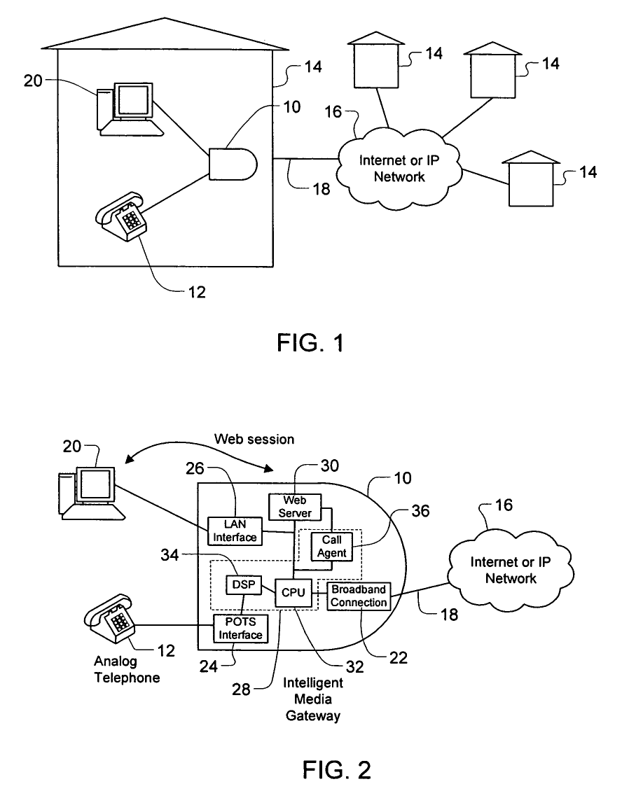

Referring to FIG. 1, an intelligent media gateway 10 provides packet-switched telephony services and advanced telephone call features to an analog telephone handset 12. The intelligent media gateway 10 can be used with a telephone handset 12 that is inexpensive and located at a residential location 14, instead of using a more expensive proprietary handset to provide the advanced telephone call features. Although the exemplary embodiment of the present invention focuses on the telephony services, the intelligent media gateway 10 is also capable of providing other services such as data and video. Although the intelligent media gateway 10 provides significant advantages to residential users, the media gateway 10 can also be used to provide advanced telephony features at other locations, such as a business location.

The intelligent media gateway 10 is connected between the telephone handset 12 and a network 16, such as the Internet or other type of IP network. The preferred embodiment of the intelligent media gateway 10 connects to the network 16 using broadband media 18 including, but not limited to, Asymmetric Digital Subscriber Line (ADSL), Very High Speed Digital Subscriber Line (VDSL), cable using Data Over Cable Service Interface Specifications (DOCSIS), and wireless. Inbound and outbound telephone calls are preferably transmitted and received by the intelligent media gateway 10 using the Voice over IP (VoIP) protocol, although other types of packet-switched telephony protocols are contemplated. Telephone calls are transmitted and received over the network 16 to and from other locations 14 connected to the network 16.

A computer device 20 can be connected to the intelligent media gateway 10 for interfacing with the media gateway 10 to activate and configure the advanced telephone call features. The advanced telephony features include, but are not limited to, call forwarding and blocking, restricting calls, call waiting, and customized ring tones. Other types of user interface devices, such as an Interactive Voice Response (IVR) based user interface, can also be connected to the media gateway 10. Alternatively, the computer device 20 or other user interface device can be incorporated in the intelligent media gateway 10.

A preferred embodiment of the intelligent media gateway 10, as shown in FIG. 2, includes at least one broadband connection 22 that connects to the network 16, at least one telephone interface 24 that connects to the telephone handset 12, and at least one computer device interface 26 that connects to the computer device 20. The media gateway 10 also includes a processing system 28 for processing the inbound and outbound telephone calls. A user interface system 30 provides the user interface for activating and configuring the telephone call features of the media gateway 10.

The broadband connection 22 transmits and receives the digital data including telephone call data (e.g., caller ID) and voice data corresponding to the telephone calls. The broadband connection 22 can be any type of connection known to those skilled in the art for connecting to and handling communications over one or more of the different types of broadband media 18 (e.g., ADSL, VDSL, DOCSIS or Wireless). The preferred broadband connection 22 is a physical connection that supports IP protocol transport at broadband data rates, for example, greater than about 200 kbps. The computer device interface 26 can be any type of interface known to one skilled in the art for connecting to a computer or network. One example of the computer device interface 26 is a local area network (LAN) interface.

The telephone interface 24 receives and transmits the analog voice signals corresponding to the telephone calls. The telephone interface 24 can be any type of interface known to those skilled in the art for connecting to a telephone. One example of the telephone interface 24 is a POTS (Plain Old Telephone Service) interface. Although one telephone interface 24 is shown, the media gateway 10 can include multiple telephone interfaces 24.

The preferred embodiment of the processing system 28 includes a central processing unit (CPU) 32, a digital signal processor (DSP) 34 and an intelligent call agent 36. The CPU 32 coordinates the various functions and components in the media gateway 10. The DSP 34 converts the analog voice signals from the analog telephone handset 12 to digital IP voice packets and vice versa. The DSP 34 can be implemented using existing voice encoders such as G.711 or G.729 and IP/Real Time Protocol packet protocol.

The intelligent call agent 36 handles the inbound and outbound telephone calls based on call handling rules and user defined parameters. The intelligent call agent 36 is preferably implemented as software running on the media gateway. The software implementation allows the user of the system to configure and use intelligent calling features without the support of the telephone system to configure and use intelligent calling features without the support of the telephone system provider through the use of the integrated user interface. The call handling rules include, but are not limited to, call forwarding rules, call waiting rules, call restricting rules and ring tone rules. The user defined parameters include, but are not limited to, inbound caller ID, outbound dialed number, time and date of call, call forwarding logic and ring cadences.

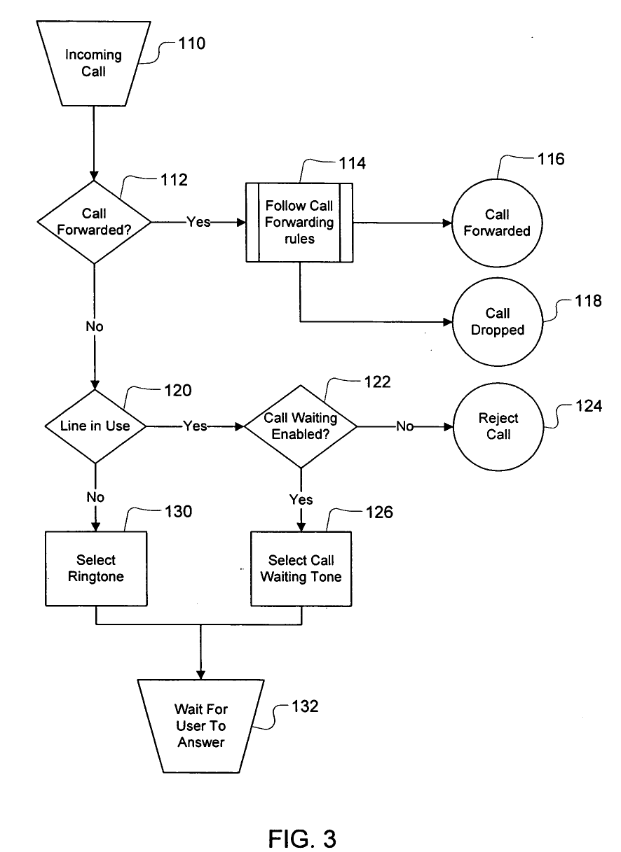

One method of processing incoming or inbound telephone calls is shown in FIG. 3. When the media gateway receives an invitation to accept an incoming telephone call fro the IP network, step 110, the call agent consults the user defined parameters to determine if the call is to be forwarded, step 112, for example, by comparing the inbound caller ID to the inbound caller IDs in the user-defined call forwarding list. If the call is to be forwarded, the call agent applies the call forwarding rules, step 114. For example, the call forwarding rules dictate the days and times that the call should be forwarded and the call forwarding destination. The call can then be forwarded, step 116, or dropped, step 118, depending upon the call forwarding rules.

If the call is not to be forwarded, the call agent determines if the line is in use, step 120. If the line is in use, the call agent consults the user defined parameters to determine if call waiting has been enabled, step 122. If call waiting has not been enabled, the call is rejected, step 124. If call waiting has been enabled, the call agent consults the user defined parameters to determine if the call waiting tone that should be used, step 126.

If the line is not in use, the call agent consults the user defined parameters to determine the ring tone that should be used, step 130. The call is then placed using the selected ring tone and waits for the user to answer, step 132.

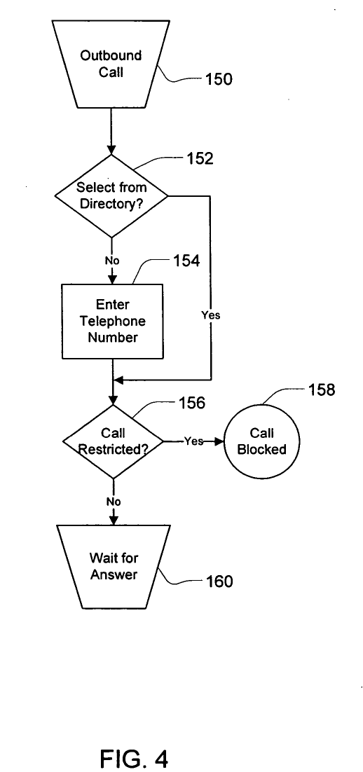

One method of processing outbound calls is shown in FIG. 4. When an outbound call is to be placed, the user can select a name and/or telephone number from a directory, step 152, or can manually enter a telephone number, step 154. The call agent consults with the user defined parameters to determine if the call is restricted, step 156, for example, based on the outbound dialed number. If the call is restricted, the outbound call will be blocked, step 158. If the call is not restricted, the call will be placed and the user waits for an answer, step 160.

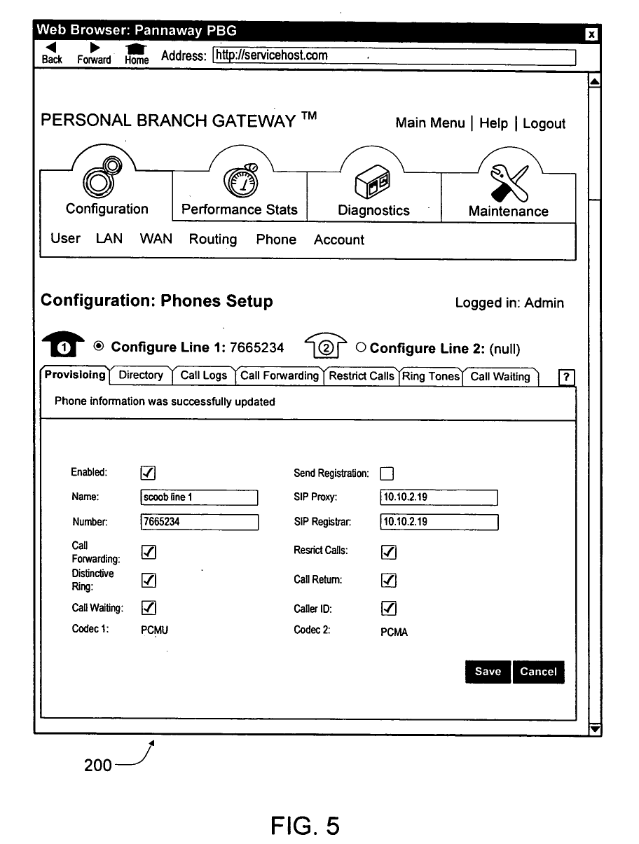

The preferred embodiment of the user interface system 30 includes an embedded web server on the intelligent media gateway 10. The user uses the computer device 20 to log onto the web server and display the web pages used to configure one or more telephone lines and to activate and configure the call features handled by the media gateway 10. The web pages allow the user to enter the user defined parameters, for example, by providing fields, check boxes, menus and other similar user interface objects. Screen shots of exemplary web pages are shown in FIGS. 5-9.

One example of a phones set up or provisioning web page 200 is shown in FIG. 5. Using the provisioning web page, the user or service provider can enable a telephone line, enter a name and telephone number for the line, and activate call features such as call forwarding, distinctive rings, call waiting, restrict calls, call return, and caller ID. The user or service provider can also configure the Session Initiation Protocol (SIP) proxy and registrar servers.

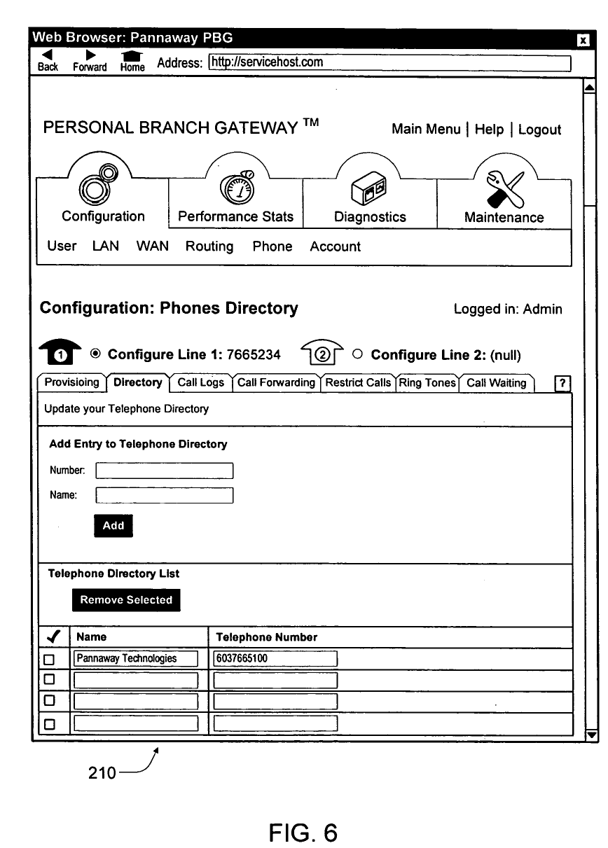

One example of a phone directory web page 210 is shown in FIG. 6. Using the directory web page 210, the user can add and remove names and corresponding telephone numbers to a telephone directory stored on the media gateway 10.

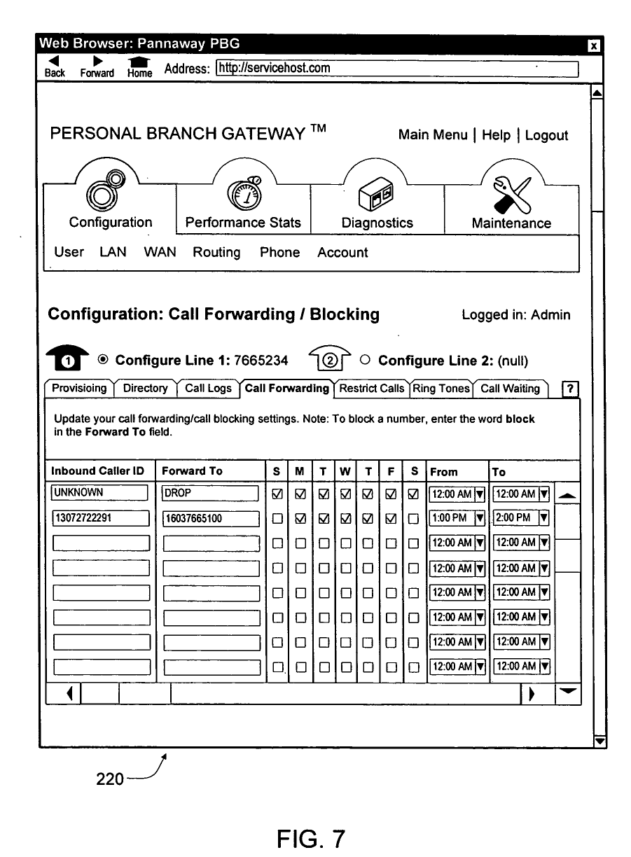

One example of a call forwarding/blocking web page 220 is shown in FIG. 7. Using the call forwarding/blocking web page 220, the user can enter an inbound caller ID and specify a telephone number for forwarding an inbound telephone call having that caller ID. The user can also drop or block calls from a particular inbound caller ID. The user can also configure the call forwarding and blocking for certain days and times.

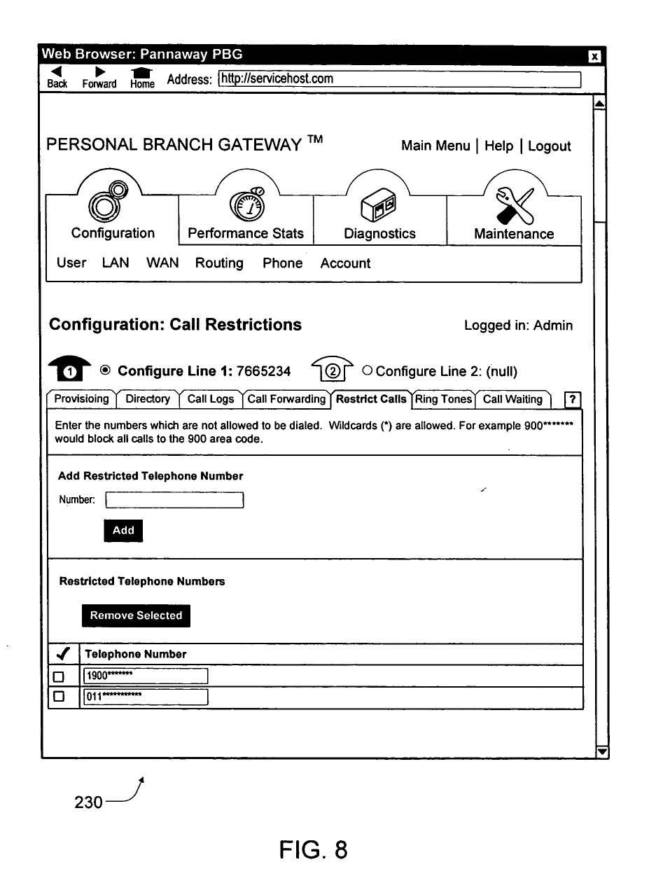

One example of a restrict call web page 230 is shown in FIG. 8. Using the restrict call web page 230, the user can enter restricted telephone numbers to restrict outbound telephone calls to the specified number. Wildcard characters (e.g., “*”) can be entered to restrict all calls having a specified area code.

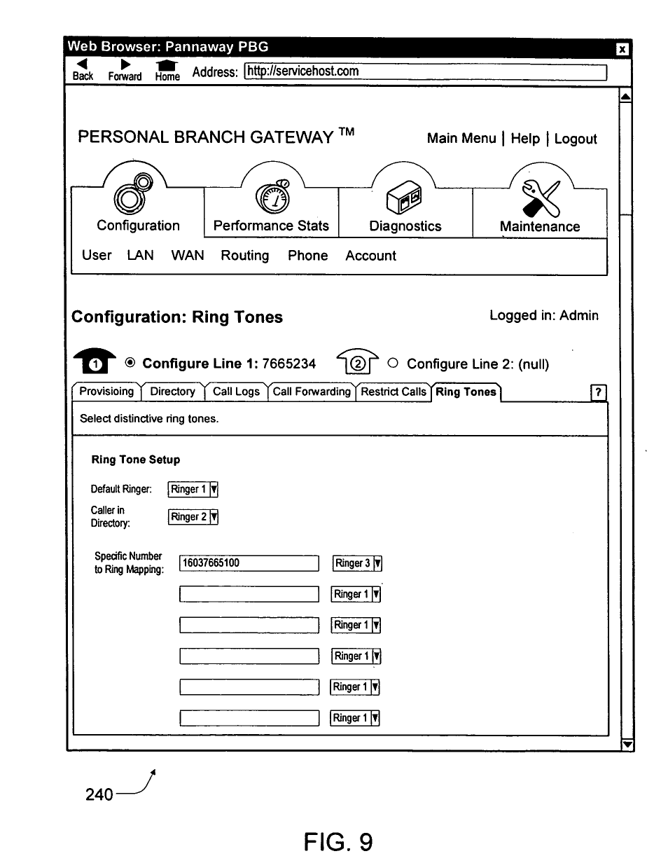

One example of a ring tones setup web page 240 is shown in FIG. 9. Using the ring tones setup web page 240, the user can specify a telephone number and a type of ringer to be mapped to the telephone number.

The user defined parameters entered using the web pages are stored on the gateway as persistent configuration data. A data structure incorporating Extensible Markup Language (XML) is an example of a preferred embodiment in which the user data can be stored in a manner that is largely independent of the gateway hardware as well as the user interface type or location. As an example, an alternative user interface such as a remote management software application could send XML data to the gateway for remote configuration. The intelligent call agent 36 can then process the stored XML configuration data to process the inbound and outbound telephone calls as described above.

Accordingly, the intelligent media gateway provides advanced telephony features to a conventional analog telephone using packet-switched telephony and allows a customer (e.g., a residential user) to activate and configure the advanced telephony features locally.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

1. An intelligent media gateway for providing telephone call features to an analog telephone using packet-switched telephony, said intelligent media gateway comprising:
at least one broadband connection for receiving and transmitting digital data corresponding to inbound and outbound telephone calls, respectively, wherein said digital data includes telephone call data and voice data;
at least one telephone interface for receiving and transmitting analog voice signals corresponding to said inbound and said outbound telephone calls;
a call processing system for processing said inbound and outbound telephone calls and for converting between said voice data and said analog voice signals, said call processing system including an intelligent call agent for managing said telephone calls according to said telephone call data and user defined rules; and
a user interface system for providing a user interface for configuring said intelligent call agent and for creating said user define rules.

2. The intelligent media gateway of claim 1 further comprising at least one computer interface for receiving computer signals and for interacting with said user interface system to provide said user interface.

3. The intelligent media gateway of claim 2 wherein said at least one computer interface includes at least one LAN interface.

4. The intelligent media gateway of claim 1 wherein said broadband connection supports data rates greater than about 200 kbps.

5. The intelligent media gateway of claim 1 wherein said processing system includes a digital signal processor for converting between said voice data and said analog voice signals.

6. The intelligent media gateway of claim 4 wherein said digital signal processor converts between said analog voice signals and said voice data using voice over IP (VoIP).

7. The intelligent media gateway of claim of claim 5 wherein said processing system includes a central processing unit (CPU) for coordinating the processing of said inbound and outbound telephone calls.

8. The intelligent media gateway of claim 1 wherein said user interface system includes an embedded web server for generating web pages to provide said user interface.

9. The intelligent media gateway of claim 1 wherein said user defined rules include at least one rule for forwarding inbound telephone calls.

10. The intelligent media gateway of claim 1 wherein said user defined rules include at least one rule for restricting outbound telephone calls.

11. The intelligent media gateway of claim 1 wherein said user defined rules include at least one rule for mapping inbound telephone calls to different types of rings.

12. The intelligent media gateway of claim 1 wherein said user defined rules include at least one rule for enabling call waiting.

13. The intelligent media gateway of claim 1 wherein said telephone interface is a plain old telephone service (POTS) interface.

14. The intelligent media gateway of claim 1 wherein said user interface system is an interactive voice response (IVR) system.

15. A method of managing packet-switched telephone calls, said method comprising the steps of:
providing call handling rules on a media gateway for handling inbound and/or outbound telephone calls;
providing a user interface to said media gateway for configuring said call handling rules;
when an invitation to accept at least one inbound telephone call using packet-switched telephony is received, consulting said call handling rules on said media gateway to determine how said inbound telephone call is handled; and
processing said inbound telephone call based on said call handling rules.

16. The method of claim 15 wherein the step of providing a user interface includes displaying web pages.

17. The method of claim 15 wherein said call handling rules include at least one rule for forwarding inbound telephone calls, and wherein the step of processing said inbound telephone call includes forwarding said inbound telephone call based upon inbound caller ID information.

18. The method of claim 15 further comprising the step of: when an outbound telephone call is placed, consulting said call handling rules to determine how said outbound telephone call is handled.

19. The method of claim 18 wherein said user defined rules include at least one rule for restricting outbound telephone calls based upon an outbound dialed number.

20. The method of claim 15 wherein said user defined rules include at least one rule for mapping inbound telephone calls to different types of rings, and wherein the step of processing said inbound telephone call includes generating a ring tone for said inbound telephone call based upon inbound caller ID information.
